(19) United States
(12) Patent Application Publication
(10) Pub. No.: US 2011/0117513 A1
(43) Pub. Date: May 19, 2011

(54) DEVICE FOR THE THERMAL TREATMENT OF WORKPIECES

(75) Inventor: Richard Kressmann, Zell (DE)

(73) Assignee: ERSA GmbH

(21) Appl. No.: 13/003,910

(22) PCT Filed: May 18, 2009
(86) PCT No.: PCT/DE09/00675

§ 371 Date: Jan. 13, 2011

(30) Foreign Application Priority Data
Jul. 15, 2008 (DE) 10 2008 033 225.9
Sep. 1, 2008 (DE) 20 2008 011 595.7

(51) Int. Cl. F27D 1/00

(52) U.S. Cl. 432/77

(57) ABSTRACT

The invention relates to a device for the thermal treatment of workpieces, in particular printed circuit boards or the like equipped with electrical and electronic components, said device comprising a process chamber (1) in which there is formed or arranged at least one heating zone or cooling zone which has a heating device or a cooling device and through which the workpieces are transported along a transporting section while being heated or cooled, wherein a pressurized gaseous fluid can be introduced into the heating zone or the cooling zone via inflow openings (18).

The present invention relates to a device for the thermal treatment of workpieces according to the preamble of patent claim 1.

As is known from reflow soldering installations shown in the state of the art, several successively arranged process chambers which have heating zones or cooling zones are heated to reach a respectively preset temperature, wherein in particular a preheating zone, a reflow zone and a cooling zone are provided for the purpose of exposing the component or the printed circuit board to be soldered to different temperatures. It is common practice to supply the heat of a heating element to the components to be soldered by means of convection and by using blowers in such a manner that a tempered air flow flows past the components. The heat transfer to the printed circuit boards is essentially contingent upon the temperature and the flow rate of the gas within the process chamber. The blower motors of such convection modules are rpm(revolutions per minute)-regulated in order to be able to control the heat transfer rates. The generation of the air flow using blowers can be considered as constituting a highly complex technique, wherein in particular in the case of high flow rates a drawback is encountered with respect to the efficiency of such systems.

Further heating modules for soldering installations known from the state of the art feature medium-wave to long-wave infrared emitters. Said preheating modules heat the components by means of radiation heat transfer. A drawback of such heating cassettes resides in the efficiency of the energy transfer.

Moreover, document DE 202 03 599 U1 discloses a device for reflow soldering, wherein the component assembly to be soldered is transported along a transport plane through a heating zone. Above the transport plane, a nozzle is provided which has a slot-shaped nozzle opening and a slot-shaped channel cross-section which essentially corresponds to the width of the component assembly. The process gas jet is widened via a deflector surface which lies at a distance from the nozzle opening. In this device, the process gas serves for supplying the component with the necessary amount of heat. This measure is afflicted with the disadvantage that it is necessary to introduce a very large amount of process gas into the process chamber.

Starting from this state of the art, it is an object of the present invention to provide a device for the thermal treatment of workpieces, by means of which the drawbacks encountered in the state of the art can be overcome in order to enable in particular a more efficient heat transfer.

According to the invention, this object is realized by a device according to the teaching of patent claim 1.

Preferred embodiments of the invention are the subject-matter of the subclaims.

Firstly, in a manner known per se, the device for the thermal treatment of workpieces, in particular printed circuit boards or the like equipped with electrical or electronic components, comprises a process chamber in which there is formed or arranged at least one heating zone or cooling zone which has a heating device or a cooling device. In this regard, it is possible to transport workpieces along a transporting section through said zones while heating or cooling them. Such devices preferably feature a modular configuration, wherein the cooling modules and heating modules can be disposed in succession. In this way, a component which is transported along the different cooling zones or heating zones can be correspondingly heated or cooled. The temperature prevailing in the different modules is measured using temperature sensors or pyrometers, and can then be controlled.

According to the invention, a pressurized gaseous fluid can be introduced into the heating zones or the cooling zones via inflow openings. In this process, the gaseous fluid is blown at a high velocity through the inflow openings in the form of a volume flow which is small in relation to the volume of the process chamber, and, in the region of the inflow openings, carries along the ambient gas atmosphere in the process chamber. This larger and in particular strongly swirling volume flow supports in particular the radiation heat transfer from the heating or cooling device to the components and vice versa with the aid of an additional convective heat transfer. As a result, such a device enables an increase in the efficiency of the heat transfer by increasing the amount of heat transferred by way of introducing a gas using convection. In this regard, in the simplest case, the gaseous fluid may be composed of compressed air or else also of an inert gas or any other common process gases which are introduced into the process chamber via the inflow openings. Due to the small volume flow, the temperature of the gas is not of key relevance. Thus, in particular non-preheated compressed air from a compressed air reservoir can be employed. The gas merely serves the purpose of setting in motion the gas contained in the chamber.

Preferably, the inflow openings are arranged at least at one pipe section which is connected to a pressurized fluid source. The inflow openings may be formed in the shape of a nozzle and may generate the type of flow corresponding to their openings. Provision is exemplarily made for subjecting the fluid source to pressure using a compressor or a pressurized gas bottle or else for connecting the fluid source to an available compressed air network.

According to another preferred exemplary embodiment, provision is made for arranging the inflow openings at least at one wall of a hollow chamber which is connected to a pressurized fluid source. In this context, the hollow chamber may be arranged at any arbitrary position in the process chamber such that the fluid can be supplied to virtually all optional positions in the process chamber via the inflow openings in the wall or in the walls of the hollow chamber. According to another realization, however, provision is made for the wall, which has the inflow openings, forming a part of the outer wall of the process chamber.

The arrangement of the pipe sections is basically optional and is essentially contingent upon the position of the process chamber to which the fluid to be introduced shall be transported. In order to concentrate in particular the flow in the region of the transporting section, according to a preferred exemplary embodiment, a plurality of pipe sections arranged in the process chamber are provided, which extend substantially in parallel to the transporting section. Here, the pipe sections can be arranged in succession and/or side by side.

According to another preferred exemplary embodiment, provision is made for arranging the pipe sections substantially transverse to or at an angle to the transporting direction of the workpieces.

In this regard, the transported workpieces can be supplied with a different type of gas from different pipe sections, for example in different regions of the process chamber.

The arrangement of the inflow openings at the pipe sections is also basically optional. Thus, the openings may for instance be arranged at the pipe sections so as to be statistically distributed. According to an exemplary embodiment of the invention, however, the inflow openings are arranged at the pipe sections so as to be linearly disposed in succession in order to ensure a uniform flow distribution and hence a uniform convection.

Alternatively, the inflow openings for instance may be arranged side by side or else may be offset at an angle with respect to one another. Thus, a more comprehensive flow characteristic can be realized, which makes it possible to reach large parts of the process chamber by means of a greater flow of the gas volume.

Preferably, the distance between respectively adjacent pipe sections is 10 mm and 100 mm, wherein on the one hand, a sufficiently large gas volume flow can be generated, and at the same time, a sufficient amount of radiation heat is allowed to be emitted between the pipe sections. To this end, the pipe sections for instance are arranged in parallel.

The distance of the pipe sections from the workpieces to be thermally treated preferably is between 20 mm and 50 mm.

According to another embodiment, provision is made for arranging the pipe sections so as to be adjustable in their distance to one another and/or in their distance to the workpieces to be treated. This can be realized for instance using a manually-actuated or motor-driven adjustment device which can additionally be controlled or regulated as a function of process parameters, such as the temperature of the atmosphere prevailing in the process chamber or the like.

According to another preferred realization, provision is made for arranging the pipe sections so as to be rotatable about their longitudinal axis. In this way, the direction of the volume flow can be adjusted in a simple manner.

The diameter of the inflow openings shall be set in particular in consideration of the trajectory path, the gas pressure and the distance of the inflow openings to one another. Preferably, the diameter is between 2 mm and 0.01 mm, in particular between 0.5 mm and 0.05 mm. Thus, it is possible to ensure reduced gas consumption and a volume flow of the inflowing fluid which is sufficiently small with respect to the volume of the process chamber. The inflowing gas is capable of carrying along the ambient atmosphere in the process chamber and, as a result, can cause a relatively large gas flow to the workpieces. The suggested small diameters make it possible for the inflowing gas to reach high flow rates subject to reduced gas consumption. In this process, the gas flow does not introduce any amount of heat into the chamber, but rather only supports the heat transfer from the heated process gas atmosphere prevailing in the process chamber to the workpiece. Thus, a convective heat transfer can be carried out in addition to the radiation heat transfer.

The distance between respectively adjacent inflow openings is preferably between 5 mm and 100 mm.

According to another preferred exemplary embodiment, provision is made for the pressure differential between the process chamber and the pressurized fluid being between 1 bar and 50 bar. Thus, high flow rates can be generated via the inflow openings into the process chamber, which form the basis for a high degree of swirl, a large effective volume flow onto the workpieces to be treated and thus a high convective energy transfer. This pressure region additionally enables a high inflow depth and variability thereof.

The type of the heating device or the cooling device is irrelevant for the nature of the invention. According to an exemplary embodiment, however, the heating device or the cooling device has at least one panel heating element or panel cooling element, wherein the pipe sections are arranged between the workpiece and the panel heating element or the panel cooling element. Here, in the simplest case, a wall region of the process chamber may also serve as the panel heating element and is correspondingly heated from the outside or else has an infrared heating element.

According to another embodiment, the heating device or the cooling device features at least one rod-shaped or tubular heating element or cooling element. In the simplest case, these elements may be pipes having superheated steam, hot water or a cooling medium flowing through them. Here, the heating elements or the cooling elements may be arranged between the pipe sections, between the pipe sections and the workpieces to be treated or else between the pipe sections and a wall of the process chamber.

Hereinafter, the inventive device will be described in greater detail with reference to the drawings, which illustrate only preferred embodiments.

In the drawings:

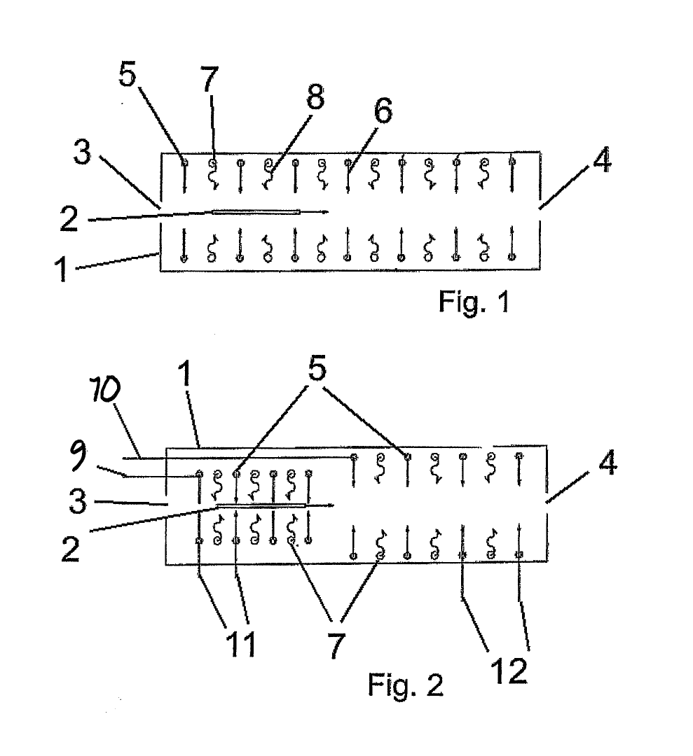

FIG. 1 shows a process chamber having pipe sections arranged above and below and arranged side by side, and having heating elements or cooling elements;

FIG. 2 shows a process chamber having pipe sections arranged above and below and arranged side by side, and having heating elements or cooling elements disposed at a variable distance to the transport plane;

FIG. 3 shows a process chamber having pipe sections arranged above and below and arranged side by side, and having heating elements or cooling elements, wherein the heating elements are partially screened with the aid of a reflector element.

FIG. 4 shows a process chamber having a panel heating element in which several inflow openings are provided;

FIG. 5 shows a cut through a pipe section with two inflow openings;

FIG. 6 shows a cut through a pipe section with one inflow opening;

FIG. 7 shows a module with a register composed of pipe sections and a heating device or a cooling device;

FIG. 8 shows a sectional view of the arrangement of a register composed of pipe sections and heating elements or cooling elements of the module illustrated in FIG. 7;

FIG. 9 shows the arrangement of the pipe sections in the direction of the transporting section;

FIG. 10 shows the arrangement of the pipe sections orthogonally to the direction of the transporting direction; and

FIG. 11 shows the arrangement of several pipe registers and heating elements or cooling elements along a transporting section.

The process chamber 1 illustrated in FIG. 1 is centrally traversed by a transporting unit 2, which enters into the process chamber 1 via a first chamber opening 3 until the transporting unit 2 exits the process chamber via the second chamber opening 4. In the process chamber 1, pipe sections 5, from which a gas flow 6 flows to the chamber axis, are respectively provided above and below so as to be opposed to one another. In addition to a pipe section 5, provision is made for alternately arranging respectively one heating element, from which heat radiation 8 is equally emitted towards the center of the chamber, which is rendered apparent by the curved vector. The alternate arrangement of heat-emitting elements 7 and pipe sections 5 enhances the efficiency of the heat transfer to a component. This component is transported along the transporting section through the process chamber 1 using the transporting unit 2 and in addition is heated by the gas flow 6, which has been heated through contact with the heat-emitting elements 7 or the surfaces heated by the same within the process chamber.

FIG. 2 renders apparent the variable arrangement of the heating elements 7 and the inflow openings 5 with respect to the transporting section of the transporting unit 2. For this purpose, a process chamber 1 is moved by a transporting unit 2 from a first chamber opening 3 to a second chamber opening 4, wherein in a first section, the inflow openings 5 and the heating elements 7 are arranged in a first position 9 which lies closer to the transporting section, and in another section, the inflow openings 5 and the heating elements 7 are arranged in a second position 10 which is situated at a greater distance relative to the transporting section. It is also clearly apparent here that the lateral distance of the heating elements 7 and the pipe sections 5 is also variable, since the distance between two pipe sections 5 has a first width 11 and a second width 12.

FIG. 3 shows another option for manipulating the heat radiation 8. To this end, in a process chamber 1 which is traversed by a transporting unit 2 from a first chamber opening 3 to a second chamber opening 4, a heating element 7 is alternately disposed adjacent to each inlet element 5. Besides, reflector elements 13 are provided being located between the heating elements 7 and the transporting section of the transporting unit 2 and in this way laterally deflecting the heat radiation 8 emitted by the heating elements 7, resulting in a larger amount of the heat radiation 8 being allowed to directly reach the pipe sections 5 and the inflow openings arranged therein. In this way, the gas flow 6 can be efficiently heated and can move this absorbed amount of heat to the transporting unit 2 and a component arranged thereon.

FIG. 4 shows another option for heating the gas flow 6 with a variation of the flow. For this purpose, a panel heating element 14 is disposed at the process chamber 1 in parallel to the direction of the transporting section of the transporting unit 2 at the walls of the process chamber 1, said panel heating element 14 uniformly emitting the heat radiation into the process chamber 1. The inflow openings 5 are provided ahead of the panel heating element 14 in order to move the amount of heat emitted by the panel heating element 14 to the transporting unit 2. The jet of gas 6 flowing from the pipe sections 5 is divided into a first partial jet 15 and a second partial jet 16, whereby a broader distribution of the gas flow and thus an enlarged volume flow can be realized.

FIG. 5 shows a cut through a pipe section 5 having an inflow opening 18 and an adjacently arranged further inflow opening 19. In this way, the gas flow is divided into a first partial jet 15 and a second partial jet 16. This configuration of a divided process gas jet for instance is also indicated in FIG. 4. The outer diameter 20 and the inner diameter 21 represent unambiguous parameters for the pipe section, since with these parameters, in the case of a fixedly set gas pressure, the flow rate or the type of flow can be manipulated.

FIG. 6 shows a cut through a pipe section 5 having only one inflow opening 18, which generates only a first partial jet 17. This is advantageous in particular for flows to be generated at specific locations.

FIG. 7 shows an inventive module, wherein a pressurized fluid source 22 is connected to a pipe register which is composed of five pipe sections 2. A gaseous fluid flows out of each pipe section 5. Besides, a heating coil is illustrated as the heating element 7 and essentially extends over the surface of the pipe register. The illustrated pressurized fluid source 22 makes it possible in the module to realize a uniform distribution of the gas pressure in the different pipe sections 5.

FIG. 8 shows a cut through the module illustrated in FIG. 7, wherein a first partial jet 15 and a second partial jet 16 flow out of the pipe sections 5 and are heated by the heat emitted by the heating elements 7. In addition, reflector elements 13 are provided, which serve for moving the heat efficiently to the pipe sections 5.

FIGS. 9 and 10 show the arrangement of the pipe sections 5 with respect to the direction of the transporting section 23 of the transporting unit 2. FIG. 9 correspondingly shows the arrangement of the pipe sections 5 in parallel to the direction of the transporting section 23 of the transporting unit 2. The arrangement of the inflow openings 5 is correspondingly illustrated at a right angle transverse to the direction of the transporting section 23.

FIG. 11 shows the design of a soldering device having several heating modules or cooling modules arranged side by side, as described in FIG. 7. For this purpose, a process chamber 1 is composed of eight modules which each feature a register composed of pipe sections 5 and a heating element 7 in the form of a heating coil. These modules can be connected to a pressurized fluid source via a connecting element 24 and can be connected to a heating device via a connector 25.

It should be noted that the realization of the invention is not confined to the exemplary embodiments described in FIGS. 1 to 11, but a plurality of variations can be implemented as well. In particular, the type and the arrangement of the heating elements and the cooling elements as well as the arrangement of the transporting unit and the geometry of the process chamber may differ from the illustrated devices.

Hence, the invention makes a significant contribution to the improvement of the efficiency of the heat transport in soldering devices, since in addition to the heat radiation, the transferred amount of heat is increased by the heated fluid flow.

### LIST OF REFERENCE NUMERALS

01 Process chamber
02 Transporting unit
03 First chamber opening
04 Second chamber opening
05 Pipe section
06 Gas flow
07 Heating element
08 Heat radiation
09 First position
10 Second position
11 First width
12 Second width
13 Reflector element
14 Panel heating element
15 First partial jet
16 Second partial jet
17 Simple jet
18 Inflow opening
19 Further inflow opening
20 Outer diameter
21 Inner diameter
22 Pressurized fluid source
23 Transporting direction
24 Connector to pressurized fluid source
25 Connector to heating device

1. Device for the thermal treatment of workpieces, in particular printed circuit boards or the like equipped with electrical and electronic components, said device comprising a process chamber in which there is formed or arranged at least one heating zone or cooling zone which has a heating device or a cooling device and through which the workpieces are transported along a transporting section while being heated or cooled,
characterized in that
a pressurized gaseous fluid can be introduced into the heating zone or the cooling zone via inflow openings.

2. Device according to claim 1,
characterized in that
the inflow openings are arranged at least at one pipe section which is connected to a pressurized fluid source.

3. Device according to claim 1,
characterized in that
the inflow openings are arranged at least at one wall of a hollow chamber which is connected to a pressurized fluid source.

4. Device according to claim 3,
characterized in that
the wall forms a part of the outer wall of the process chamber.

5. Device according to claim 2,
characterized in that
a plurality of pipe sections are arranged in the process chamber and extend substantially in parallel to the transporting direction of the workpieces.

6. Device according to claim 2,
characterized in that
a plurality of pipe sections are arranged in the process chamber and extend substantially transverse to or at an angle to the transporting direction of the workpieces.

7. Device according to claim 2, 5 or 6,
characterized in that
the inflow openings are arranged at the pipe sections so as to be linearly disposed in succession and spaced apart from each other.

8. Device according to claims 2,
characterized in that
the inflow openings are arranged at the pipe sections side by side or are offset at an angle with respect to one another.

9. Device according to claim 5,
characterized in that
the distance between respectively adjacent pipe sections is between 10 mm and 100 mm.

10. Device according to claim 5,
characterized in that
the distance of the pipe sections (5) from the workpieces to be treated is between 20 mm and 50 mm.

11. Device according to claim 5,
characterized in that
the pipe sections can be adjusted in their distance to one another and/or in their distance from the workpieces to be treated.

12. Device according to claim 5,
characterized in that
the pipe sections can be rotated about their longitudinal axis.

13. Device according to claim 1,
characterized in that
the diameter of the inflow openings is between 2 mm and 0.01 mm, in particular between 0.5 mm and 0.05 mm.

14. Device according to claim 1,
characterized in that
the distance between respectively adjacent inflow openings is between 5 mm and 100 mm.

15. Device according to claim 1,
characterized in that
the pressure differential between the process chamber and the pressurized fluid is between 1 bar and 50 bar.

16. Device according to claim 1,
characterized in that
the heating device or the cooling device has at least one panel heating element or panel cooling element, which is arranged on the side of the pipe sections that is opposed to the workpieces to be treated.

17. Device according to claim 1,
characterized in that
the heating device or the cooling device has at least one rod-shaped or tubular heating element or cooling element, which is arranged on the side of the pipe sections that is opposed to the workpieces to be treated, between the pipe sections and the workpieces to be treated or else between adjacent pipe sections.
